(19) United States
(12) Patent Application Publication
(10) Pub. No.: US 2025/0213096 A1
(43) Pub. Date: Jul. 3, 2025

(54) CONTAINER CLEANERS AND METHODS OF USE

(71) Applicant: Vita-Mix Management Corporation, Olmsted Township, OH (US)

(72) Inventors: Matthew John Dugan, Olmsted Township, OH (US); Thomas Clynne, Olmsted Township, OH (US); Joseph Ventimiglia, Olmsted Township, OH (US)

(73) Assignee: Vita-Mix Management Corporation, Olmsted Township, OH (US)

(21) Appl. No.: 19/002,089

(22) Filed: Dec. 26, 2024

Related U.S. Application Data
(60) Provisional application No. 63/615,448, filed on Dec. 28, 2023.

(51) Int. Cl. A47L 15/00; B08B 9/28; B08B 9/36

(52) U.S. Cl. CPC A47L 15/0086; B08B 9/28; B08B 9/36

(57) ABSTRACT

Disclosed herein are container cleaners having a container cleaner body extending between a first end and a second end, the first end including a fluid inlet and the second end including a fluid outlet. A fluid pathway formed within the container cleaner body in communication with the fluid inlet and the fluid outlet. A dispensing head is disposed at the second end of the container cleaner body including one or more nozzles in communication with the fluid outlet. A brush includes a plurality of bristles disposed around at least a portion of an outer surface of the container cleaner body. A detergent reservoir is in communication with the fluid pathway of the container cleaner body.

### CROSS-REFERENCE TO RELATED APPLICATION

This application claims the benefit of co-pending U.S. Provisional Patent Application No. 63/615,448, filed Dec. 28, 2023, for “Container Cleaners And Methods Of Use,” which is hereby incorporated by reference in its entirety including the drawings.

### TECHNICAL FIELD

The present specification generally relates to apparatuses and methods for cleaning a container and, more specifically, to an apparatus and method for automatic cleaning of a container.

### BACKGROUND

Many food and/or drink containers, such as pitchers, glasses, blender containers and the like, are difficult to clean and sanitize efficiently. These types of containers are often in need of frequent cleaning, for example, in commercial environments, such as a restaurant or cocktail lounge, where the blender container may be continually used to blend different drinks. In between use of such containers by different users, the containers should generally be washed, rinsed, and sanitized in accordance with local health department guidelines. However, this can be an inefficient process as the washing, rinsing, and sanitizing of the container are each typically performed separately, often at different locations and using different tools.

### SUMMARY

In one embodiment, a container cleaner includes a container cleaner body extending between a first end and a second end, the first end including a fluid inlet and the second end including a fluid outlet; a fluid pathway formed within the container cleaner body in communication with the fluid inlet and the fluid outlet; a dispensing head disposed at the second end of the container cleaner body including one or more nozzles in communication with the fluid outlet; a brush comprising a plurality of bristles disposed around at least a portion of an outer surface of the container cleaner body; and a detergent reservoir in communication with the fluid pathway of the container cleaner body.

In another embodiment, a method for cleaning a container includes placing the container over one end of a container cleaner body; actuating a dispensing head disposed at the one end of the container cleaner body; dispensing a fluid from the dispensing head, wherein the fluid comprises water, detergent, or a mixture of water and detergent; and brushing the container with a brush comprising a plurality of bristles disposed around at least a portion of an outer surface of the container cleaner body.

In yet another embodiment, a container cleaner includes a container cleaner body including a fluid inlet disposed at a first end of the container cleaner body, a fluid outlet disposed at a second end of the container cleaner body, and a fluid pathway extending within the container cleaner body between the fluid outlet and the fluid inlet; a dispensing head disposed at the second end of the container cleaner body including one or more nozzles in communication with the fluid outlet; a brush disposed on the container cleaner body including a brush body, a plurality of bristles attached to at least a portion of an outer surface of the brush body, and one or more apertures formed on the brush body, the one or more apertures being in communication with the one or more nozzles of the dispensing head; and a detergent reservoir in communication with the fluid pathway of the container cleaner body.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of an exemplary container cleaner mounted to an associated sink, according to one or more embodiments shown and described herein;

FIG. 2 schematically depicts a cross-sectional side view of the exemplary container cleaner of FIG. 1, according to one or more embodiments shown and described herein;

FIG. 3 schematically depicts a cross-sectional side view of an exemplary container cleaner including a motor for rotating a brush, according to one or more embodiments shown and described herein;

FIG. 4 schematically depicts a cross-sectional side view of the exemplary container cleaner of FIG. 1 including a brush that rotates and/or moves vertically, according to one or more embodiments shown and described herein;

FIG. 5A schematically depicts a cross-sectional side view of the exemplary container cleaner of FIG. 1 including a brush with bristles that droop downward when the brush is stationary, according to one or more embodiments shown and described herein;

FIG. 5B schematically depicts a cross-sectional side view of the exemplary container cleaner of FIG. 1 where the bristles of the brush extend outward when the brush rotates, according to one or more embodiments shown and described herein;

FIG. 6 schematically depicts a cross sectional side view of an exemplary container cleaner including a detergent reservoir, a water line/source, and a mixing chamber, according to one or more embodiments shown and described herein;

FIG. 7 schematically depicts a cross-sectional side view of an exemplary container cleaner including one or more ultraviolet (UV) emitting lights, according to one or more embodiments shown and described herein;

FIG. 8 schematically depicts a cross-sectional side view of an exemplary container cleaner including an anti-rotation device, according to one or more embodiments shown and described herein; and

FIG. 9 depicts a flowchart of a method of using the container cleaner of FIG. 1, in accordance with various disclosed aspects herein.

### DETAILED DESCRIPTION

Embodiments described herein are directed to a container cleaner that generally includes a container cleaner body, a dispensing head for dispensing fluid such as water from a water source and/or detergent from a detergent reservoir, and a brush that may rotate and/or move. These components of the container cleaner operate together to provide the cleaning of and/or removal of foodstuff from a container placed on the container cleaner. More particularly, embodiments of the exemplary container cleaner described herein provide automated rinsing, sanitizing, and brushing of containers by an integrated unit that is mountable to or otherwise fits within a sink. As such, the efficiency of the cleaning process is improved over existing apparatuses and methods that may be limited in functionality and/or require the use of multiple different cleaning stations/locations.

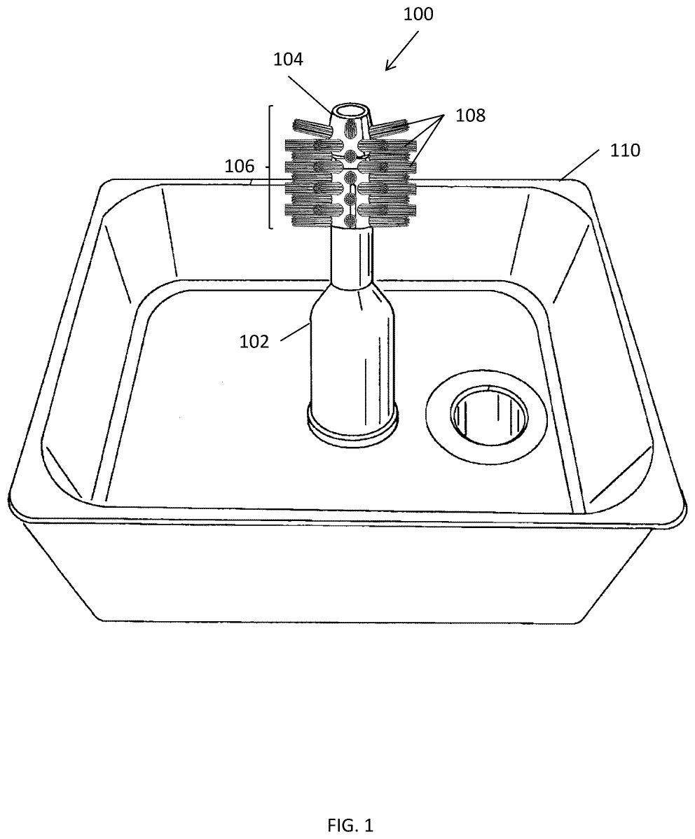

Referring now to FIG. 1, a container cleaner 100 is illustrated according to one or more embodiments described herein. The container cleaner 100 may generally include a container cleaner body 102, a dispensing head 104, and a brush 106. The container cleaner 100 may be mounted in a kitchen sink 110, such as in a commercial kitchen, café, etc., or other suitable location. Mounting of the container cleaner 100 to the kitchen sink 110 may be done in any suitable manner such as by suction, fasteners, magnets, adhesives, or the like.

In FIG. 1, the container cleaner 100 is shown installed within the sink 110, illustrating how it may be integrated into an existing sink setup. The container cleaner body 102 extends upward from a base of the sink 110, positioning the dispensing head 104 and the brush 106 at a height for cleaning containers. The brush 106, which includes a plurality of bristles 108, surrounds the dispensing head 104 and provides scrubbing action as containers are placed over it. The sink 110 collects any fluid dispensed from the dispensing head 104 during operation. The components are arranged such that the container cleaner 100 cleans containers placed over the dispensing head 104. The brush 106 is integrally formed as a one-piece, monolithic structure with the container cleaner body 102. Embodiments of the container may include an interchangeable dispensing head 104 and an interchangeable brush 106. The container cleaner 100 may include interchangeable components to suit different containers.

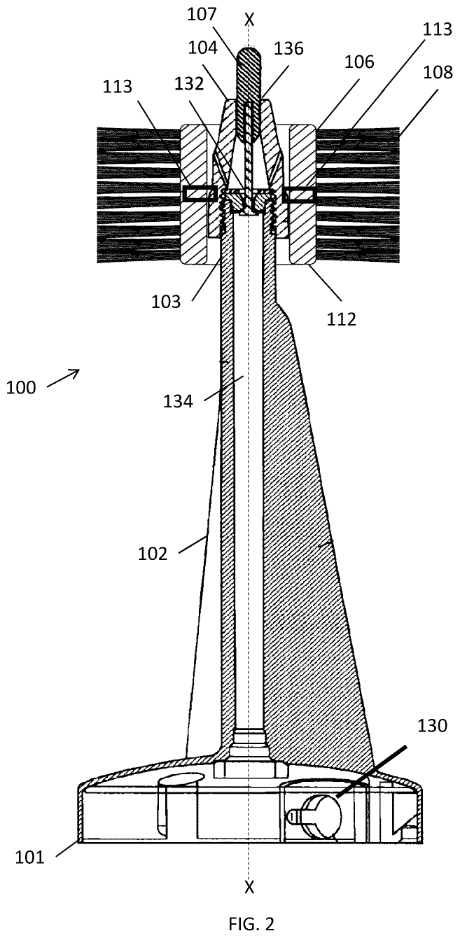

Referring to FIG. 2, the container cleaner body 102 extends between a first end 101 and a second end 103 opposite the first end 101 in a generally vertical manner. The first end 101 includes a fluid inlet 130 and the second end 103 includes a fluid outlet 132. A fluid pathway 134 extends within the container cleaner body 102 and is in communication with the fluid inlet 130 and the fluid outlet 132.

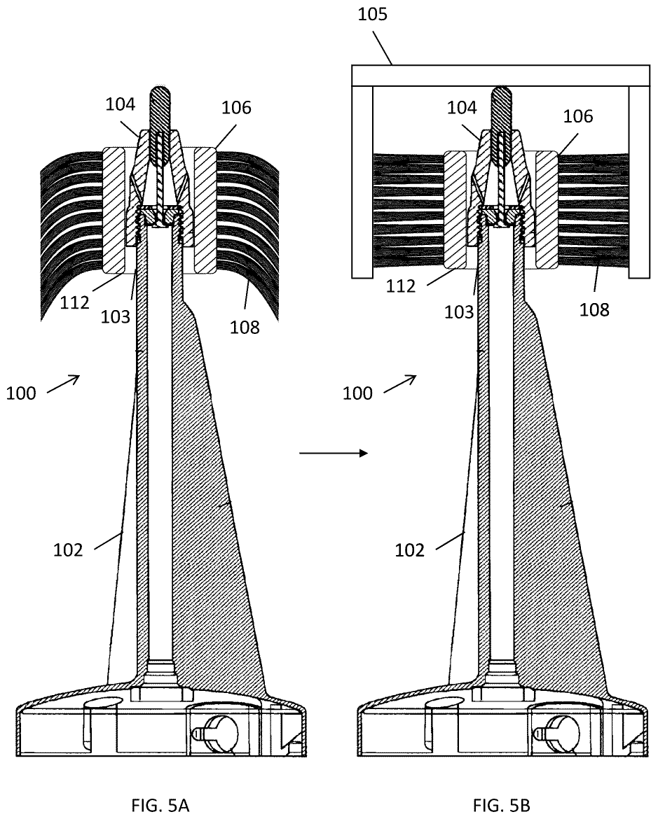

The dispensing head 104 is disposed at the second end 103 of the container cleaner body 102 and has one or more nozzles 136 in communication with the fluid outlet 132. The dispensing head 104 is configured to dispense, through the one or more nozzles 136, liquid, such as water, liquid detergent or sanitizer, a mix of water and detergent, or the like. The brush 106 is generally defined by a plurality of bristles 108 disposed around at least a portion of an outer surface of the container cleaner body 102. The plurality of bristles 108 are generally disposed adjacent to the dispensing head 104 and extend outward from the dispensing head 104 at various angles. The plurality of bristles 108 may extend a predetermined distance from the dispensing head 104. In operation, a user may place a dirty container (e.g., container 105 shown in FIG. 5B) on the dispensing head 104. In some embodiments, the dispensing head 104 is configured such that the weight of the container (e.g., container 105 shown in FIG. 5B) actuates dispensing by the dispensing head 104. For example, a user may have to press the container down, thereby depressing the dispensing head 104, to actuate dispensing. The user may move the container around to allow the plurality of bristles 108 of the brush 106 to loosen any foodstuff stuck therein.

Referring still to FIG. 2, the brush 106 may include a brush body 112 and the plurality of bristles 108 are attached to the brush body 112. More particularly, the plurality of bristles 108 are attached to at least a portion of an outer surface of the brush body 112. In some embodiments, the bristles 108 may be made from materials such as rubber. In some embodiments, the brush 106 or brush body 112 may be integrally formed with the container cleaner body 102. In other embodiments, the brush body 112 may be formed as a separate and removable piece to allow for disposal or replacement of the brush 106. The brush body 112 may include nozzles 136 or other fluid pathways (e.g., one or more apertures 113) to allow dispensing from the dispensing head 104. In some examples, one or more nozzles 136 on the dispensing head 104 are aligned with the one or more apertures 113 formed on the brush body 112. That is, the one or more apertures 113 of the brush body 112 are in communication with the one or more nozzles 136 of the dispensing head 104. The brush body 112 may be rotatable about an axis, such as a longitudinal axis X-X of the container cleaner body 102 extending between the first end 101 and the second end 103. This may allow the brush 106 to clean an associated container without a user moving the container, and/or may further assist a user in cleaning the container.

The plurality of bristles 108 may have different angles, groupings, patterns, sizes, and/or shapes to account for the different geometries of containers. For instance, bristles 108 near the top of the dispensing head 104 may be angled upwards to clean around various container features, such as a blade in a blender pitcher, and may be shorter than the bristles 108 on the side of the dispensing head 104. That is, the bristles 108 on the side of the dispensing head 104 may extend further to reach the walls of a container that may be placed on the container cleaner 100.

The plurality of bristles 108 of the brush 106 may be stiff, soft, or a combination of both. In some embodiments, the plurality of bristles 108 are made of a high durometer rubber. In some embodiments, the brush 106 is adapted to rotate. With reference to FIGS. 5A and 5B, in embodiments utilizing soft bristles or bristles made of high durometer rubber, the plurality of bristles 108 may initially droop (see FIG. 5A) towards the bottom of a sink (such as sink 110) when the brush 106 is stationary and may extend outward (see FIG. 5B) when the brush 106 is rotating. This may allow differently sized and shaped containers (e.g., container 105 shown in FIG. 5B) to be utilized with the container cleaner 100. Moreover, in some embodiments, the brush 106 may be manually interchangeable with different sizes to accommodate the use of differently sized containers.

Embodiments of the container cleaner 100 may include spray patterns that are not one-size-fits-all, and effective rinse times may vary. The container cleaner 100 may accommodate different spray patterns with allocated timings. The container cleaner 100 may utilize multiple dispensing heads 104. Each dispensing head 104 may have nozzle patterns optimized for different applications. The nozzles 136 may be offset and have different actuation forces to accommodate different objects. As for actuation, the container 105 may cause the dispensing head 104 to actuate based on weight. For example, a heavier container 105 may require a different spray pattern or a longer rinsing time. The container cleaner 100 may incorporate electronic controls for variable rinse times. A heavier container 105 may depress the dispensing head 104 more resulting in the longer rinse time. Therefore, a lighter container 105 may result in a shorter rinse time.

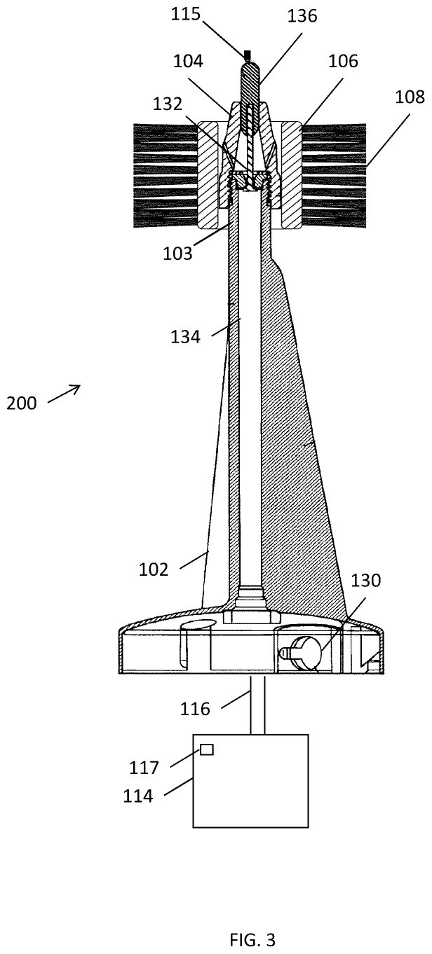

Referring to FIG. 3, another embodiment of a container cleaner 200 is illustrated. It should be appreciated that the container cleaner 200 is similar to the container cleaner 100 of FIG. 2. Thus, like reference numbers may be used to refer to like parts. In some embodiments, rotation of the brush 106 may be driven by a motor 114. In other embodiments, rotation of the brush 106 may be achieved by water pressure. If provided, the motor 114 may be disposed within the container cleaner body 102, below a sink (e.g., sink 110 in FIG. 1), or the like. In embodiments using a motor 114, the motor 114 may drive a shaft 116 connected to the brush 106. In some embodiments, the motor 114 may be actuated by a dedicated button. In other embodiments, the motor 114 may be actuated by actuation of the dispensing head 104. In embodiments where water pressure is utilized to rotate the brush 106, as water comes out of one or more apertures 113 in the dispensing head 104 and/or brush 106, the water may exert a force on the brush 106 causing the brush 106 to rotate. The one or more apertures 113 of the dispensing head 104 and/or brush 106 may be angled so that the reaction force of the water on the brush 106 is also angled, thereby causing the brush 106 to rotate.

In some embodiments, the motor 114 may be disposed within the container cleaner body 102 and may be operatively connected to the brush 106 via the shaft 116. The motor 114 may be positioned below the sink 110 connected to the container cleaner body 102. The shaft 116 may extend vertically within the container cleaner body 102 and may connect to the brush body 112 of the brush 106. The brush 106 may be mounted on the shaft 116 such that rotation of the shaft 116 causes rotation of the brush 106 about the axis X-X. The motor 114 may be powered by an electrical power source. The motor 114 may be configured to rotate the shaft 116 at a predetermined speed. In some embodiments, the motor 114 may be controlled by a control unit that may receive input signals from a user interface, such as a dedicated button or from the actuation of the dispensing head 104. The dispensing head 104 may include sensors 115 (or switches) that detect when a container (e.g., container 105 shown in FIG. 5B) is placed over the dispensing head 104 and may send a signal to the control unit to activate the motor 114. Therefore, when a user places the container (e.g., container 105 shown in FIG. 5B) over the dispensing head 104, the motor 114 may be actuated to rotate the brush 106.

Embodiments of the container cleaner 200 may include one or more sensors 115 (like an imaging/scanning device) to detect placement of the container 105 (FIG. 5B). These sensors 115 may be an electrical capacitance sensor, a Near IR emitter and receiver, a Passive Infrared sensor with a wide field of view actuation, a small LIDAR sensor, or the like. The one or more sensors 115 may allow the container cleaner 200 to start dispensing automatically when the container 105 is detected. In embodiments, a solenoid valve may be provided in different and multiple areas. These sensors 115 may be located at different positions, including the top or bottom of container cleaner body 102, to reduce unintended actuation.

In embodiments of the container cleaner 200 may include the sensor 115 (e.g., an imaging/scanning device) for identifying the container 105 such as by scanning an indicia. The indicia may be, for example, an RFID or a QR code. In such embodiments, the imaging device may be communicatively coupled to the controller 117 to process the image data collected by the imaging device and determine the type of container. In other embodiments, a user may press a button or make a selection such as on a user interface that indicates the type of container and corresponds to a desired cleaning cycle. Embodiments of the container cleaner 400 may read unique identification for the container 105, enforcing a time-based sanitization cycle. For instance, if the container 105 requires a thorough sanitizing cycle every four hours, the container cleaner 400 may run a longer and more thorough washing and rinsing program.

Referring still to FIG. 3, the brush 106 may be connected to the shaft 116, which extends through the container cleaner body 102. The cam shafts may be integrated within the container cleaner body 102 and connected to the motor 114. This combined motion allows the bristles 108 of the brush 106 to reach different areas within a container (e.g., container 105 shown in FIG. 5B). The dispensing head 104, at the second end 103 of the container cleaner body 102, may distribute fluid through the nozzles 136 during movement of the brush 106. The fluid pathway 134 within the container cleaner body 102 supplies fluid from the fluid inlet 130 to the fluid outlet 132.

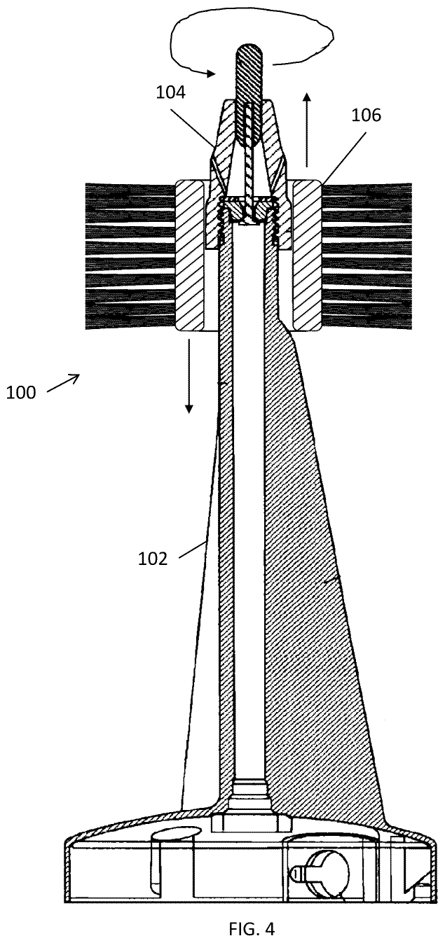

With reference to FIG. 4, and with reference again to the container cleaner 100, it is noted that other movements and patterns can be utilized for the brush 106 in addition or alternatively to the rotation motion of the brush 106 described above. For instance, in some embodiments, cam shafts may be included within the container cleaner body 102 that may allow for upward and downward motion of the brush 106 in a vertical direction with respect to the container cleaner body 102. The upward and downward motion in a vertical direction may be in addition to or instead of rotation of the brush 106.

Referring to FIG. 5A, in embodiments where the brush 106 is stationary, the plurality of bristles 108 may droop downward toward the bottom of a kitchen sink (such as sink 110 in FIG. 1). The bristles 108 may be made of soft materials, allowing them to flex under their own weight when the brush 106 is not rotating. This embodiment accommodates differently sized containers by allowing the container 105 (FIG. 5B) to be easily placed over the brush 106 without interference from extended bristles 108. The brush body 112 supports the bristles 108 in this drooped position. The dispensing head 104 remains accessible at the second end 103 of the container cleaner body 102, ready to dispense fluid when actuated.

Referring to FIG. 5B, when the brush 106 is rotating, the plurality of bristles 108 extend outward. The rotation of the brush 106 may be driven by the motor 114 (FIG. 3) or by water pressure, as previously described herein. As the brush 106 rotates about axis X-X (FIG. 2), the bristles 108 move from the drooped position, as shown in FIG. 5A, to an extended position, contacting the interior surfaces of the container 105 placed over the brush 106, as shown in FIG. 5B. This extension allows the bristles 108 to effectively contact the walls of the container 105. The brush body 112 supports the bristles 108 during rotation, as they maintain contact with the container 105. The dispensing head 104 may simultaneously dispense fluid through the nozzles 136.

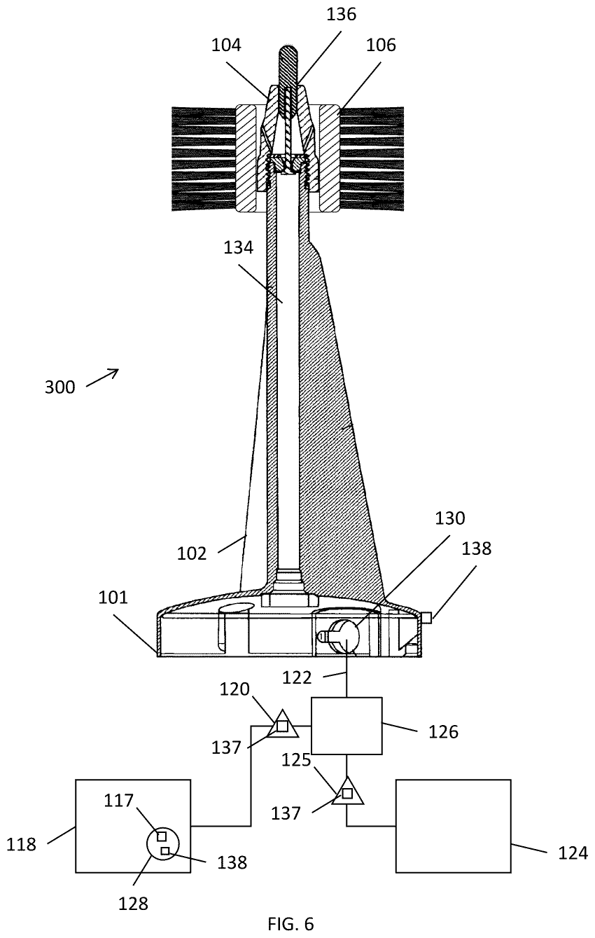

Referring now to FIG. 6, another embodiment of a container cleaner 300 is illustrated. It should be appreciated that the container cleaner 300 is similar to the container cleaner 100 of FIG. 2. Thus, like reference numbers may be used to refer to like parts. In some embodiments, the container cleaner 300 may be configured to utilize a detergent or sanitizer. As used herein, the term detergent may refer to dish soap, chemical sanitizers, or the like. As shown in FIG. 6, the detergent may be stored in a detergent reservoir 118. The detergent reservoir 118 is in communication with the fluid pathway 134 of the container cleaner body 102. In some embodiments, the detergent reservoir 118 of the container cleaner 300 may be located under a sink (e.g., sink 110 in FIG. 1). However, other locations for the detergent reservoir 118 are contemplated and possible. For example, the detergent reservoir 118 may be located within the body 102 or within the dispensing head 104 of the container cleaner 300. The detergent reservoir 118 may include or be fluidly coupled to a detergent valve 120 that is in communication with the fluid pathway 134 of the container cleaner body 102. The detergent valve 120 is configurable between an open position to dispense detergent into the fluid pathway 134 and a closed position to retain the detergent in the detergent reservoir 118. In some embodiments, the detergent valve 120 may open directly into a water line 122 supplied with water by a water source 124. The water line 122 is in communication with the fluid pathway 134 of the container cleaner body 102 via the fluid inlet 130. In other embodiments, the detergent valve 120 may open into a mixing chamber 126 where detergent from the detergent reservoir 118 is dispensed and mixed with water from the water source 124. That is, the mixing chamber 126 is in communication with at least the detergent valve 120, the fluid pathway 134, and the water line 122. The water line 122 may include a one-way valve 125 to prevent backflow of the mixture from the mixing chamber 126 into the water source 124. Once full, the mixing chamber 126 may dispense the fluid into the water line 122.

Referring still to FIG. 6, embodiments of the container cleaner 300 may include a fluid sensor 138 that monitors fluid properties such as electrical conductivity, turbidity, or fluid color. The fluid sensor 138 may detect when wash fluid reaches a certain baseline condition, indicating that the container 105 is clean. In some embodiments, a pump 128 in communication with the detergent reservoir 118 can be used to pump the detergent from the detergent reservoir 118 into the water line 122 connected to the fluid inlet 130 of the container cleaner 300. The pump 128 may include a controller 117 and a fluid sensor 138 (such as a flow meter). When the dispensing head 104 is actuated, the controller 117 may detect actuation via the fluid sensor 138. The controller 117 may open the valve 120 for a predetermined amount of time to allow detergent to be introduced into the mixing chamber 126 and/or the water line 122 from the detergent reservoir 118.

The container cleaner 300 may track time since the last sanitization using the controller 117. A visual or audible indicator may alert the operator if the container 105 requires an additional sanitizing after a set period. Instead of sanitization or disinfecting alone, the container cleaner 300 may implement contaminant reduction. Contaminant reduction may include sanitization, disinfecting, or cleaning. Different levels of fluid mixtures or cycles may be used to achieve these varying levels of cleanliness.

In some embodiments, the pump 128 may not include a controller 117. For instance, a timing valve 137 may be utilized in the detergent reservoir 118. The timing valve 137 may be actuated in response to the dispensing head 104 being actuated. The timing valve 137 may be opened for a predetermined amount of time to allow for dispensing or mixing of the detergent into the mixing chamber 126. Once the timing valve 137 closes, clean water will flow to allow for rinsing of the detergent from the container.

Embodiments of the container cleaner 300 may include two timing valves 137. One timing valve 137 may connect to a water source 124. Another timing valve 137 may connect to pressurized disinfectant. Both timing valves 137 may open together, but the disinfectant line may close earlier than the water line 122. This may allow detergent or disinfectant application first, followed by rinsing with water.

In some embodiments, the water source 124 supplies water to the water line 122, which connects to the fluid inlet 130 at the first end 101 of the container cleaner body 102. The fluid pathway 134 within the container cleaner body 102 allows the water or water-detergent mixture to travel from the fluid inlet 130 to the fluid outlet 132 at the second end 103. The mixing chamber 126 is connected to both the water line 122 and the detergent reservoir 118. When the detergent valve 120 is opened, detergent from the detergent reservoir 118 enters the mixing chamber 126 and combines with water from the water line 122. The one-way valve 125 in the water line 122 prevents backflow of detergent into the water source 124. The pump 128 may enable the movement of detergent into the mixing chamber 126. The resulting mixture flows through the fluid pathway 134 to the dispensing head 104, where it is dispensed through the nozzles 136 onto a container (e.g., container 105 shown in FIG. 5B) being cleaned.

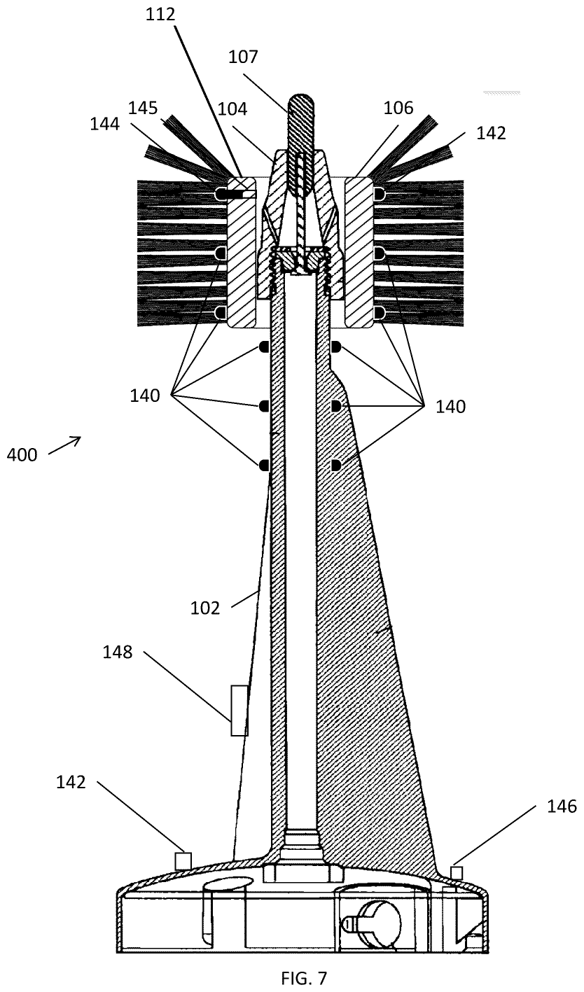

Referring now to FIG. 7, another embodiment of a container cleaner 400 is illustrated. It should be appreciated that the container cleaner 400 is similar to the container cleaner 100 of FIG. 2. Thus, like reference numbers may be used to refer to like parts. In some embodiments, the container cleaner 400 may include one or more ultraviolet (UV) emitting lights 140 to provide for additional sanitization of a container being cleaned by the container cleaner 400. The one or more UV emitting lights 140 may be configured to emit UV radiation in the 200-300 nanometer (nm) range to kill microorganisms such as airborne and surface bacteria, viruses, yeasts, and molds. The one or more UV emitting lights 140 may be disposed at one or more locations on the container cleaner 400 such that UV light can be emitted onto a container. For example, the one or more UV emitting lights 140 may be located on at least one of the container cleaner body 102, the dispensing head 104, and the brush 106 (or the brush body 112). The one or more UV emitting lights 140 may be powered through an outlet, battery (rechargeable or single use), powered by rotation of the brush 106, or the like. In some embodiments, the one or more UV emitting lights 140 may be actuated by actuation of the dispensing head 104. The one or more UV emitting lights 140 may emit UV light for as long as the container is on the dispensing head 104, or for a specified period of time while the container is on the dispensing head 104. However, other arrangements are contemplated and possible. For example, the one or more UV emitting lights 140 may emit light only if the container is left on the dispensing head 104 for a predetermined amount of time. For instance, a user may place the container on the dispensing head 104, thereby actuating the dispensing of water, detergent, and/or movement of the brush 106 for a period of time (e.g., 1-3 seconds). Once the dispensing and/or movement is complete, the one or more UV emitting lights 140 may then actuate for an additional amount of time. In other embodiments, the one or more UV emitting lights 140 may be located on a container drying rack.

In addition, the container cleaner 400 may be provided with one or more covers that can be used to help protect users against overexposure to UV light from the one or more UV emitting lights 140. In some embodiments, the container being cleaned by the container cleaner 400 may include UV protective layers or may be made of a material resistant to UV light to prevent overexposure to UV light.

The one or more UV emitting lights 140 are positioned on the container cleaner 400 to expose a container (e.g., container 105 shown in FIG. 5B) to UV radiation during the cleaning process. The UV emitting lights 140 may be mounted on the container cleaner body 102 to direct UV light toward the container 105. Alternatively, they may be placed on the dispensing head 104 or integrated into the brush 106 to target specific areas of the container (e.g., container 105 shown in FIG. 5B). When the dispensing head 104 is actuated, the UV emitting lights 140 may be activated simultaneously to emit UV light onto the interior surfaces of the container (e.g., container 105 shown in FIG. 5B). This placement allows the UV radiation to reach areas that are difficult to clean. The UV emitting lights 140 may be connected to a power source and controlled by a circuit that regulates their operation based on the presence of the container (e.g., container 105 shown in FIG. 5B) and the cleaning cycle.

Referring still to FIG. 7, embodiments of the container cleaner 400 may include an indicator light 142 that show the status of a cleaning cycle. The indicator light 142 may be one color (e.g., red) during cleaning and change to another color (e.g., green) when the cycle is complete. The indicator light 142 may also blink or change to another color (e.g., yellow) if the temperature of water is not within a predetermined range of a threshold temperature. This indicator light 142 may also indicate when a level of the detergent within the detergent reservoir 118 falls below a predetermined threshold by changing color, blinking, or the like. The indicator light 142 may be located on the container cleaner body 102 of the container cleaner 400 to provide a direct view for an operator. These same indicator light 142 could be used to indicate completion of different parts of the washing cycle.

Embodiments of the container cleaner 400 may include an air drier 144 providing air drying capability. In embodiments, once washing and rinsing is complete, a user may push downward onto an actuator 107 with additional force to stop the flow of water. A timed stream of air may then be released from the air drier 144 into the container 105 (FIG. 5B). The same function may be controlled by a timer 148 so that a rinsing period occurs first followed by a drying period in which the air drier 144 is operated. A cycle complete indicator, such as an indicator light 142 or the like, may be activated when air stops flowing from the air drier 144. In embodiments, the air exiting the air drier 144 may be heated by a heating element 145 to enhance drying. In other embodiments, the air may remain unheated to blow water droplets from the container 105 (FIG. 5B).

Embodiments of the container cleaner 400 may include a speaker 146 configured to emit an indicator tone or melody to notify the user. The speaker 146 may be integrated into some portion of the container cleaner 400 that, similar to the indicator light 142, the user may hear a short melody or spoken word that indicates information such as, for example, the completion of a step or the end of the cleaning process. Different tones may indicate different statuses or potential issues such as low detergent, as described herein.

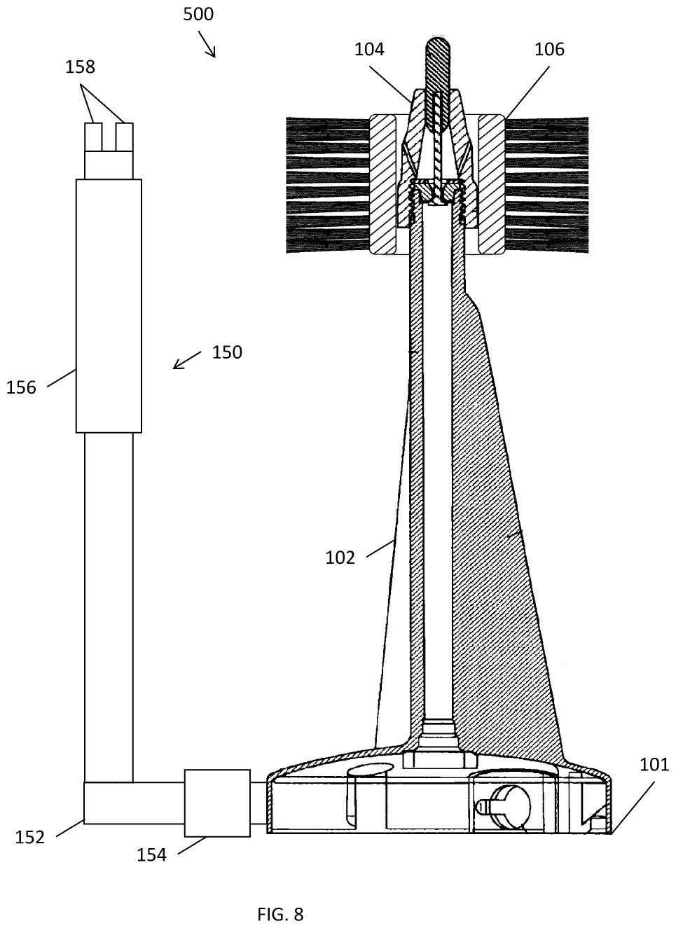

Referring now to FIG. 8, another embodiment of a container cleaner 500 is illustrated. It should be appreciated that the container cleaner 500 is similar to the container cleaner 100 of FIG. 2. Thus, like reference numbers may be used to refer to like parts. In embodiments where the brush 106 rotates and/or moves upward and downward in a vertical direction, the container cleaner 500 may include an anti-rotation device 150 that helps prevent or limit movement of the container during cleaning. The anti-rotation device 150 may generally include a clip, arm, or the like, that engages the container by contacting the exterior or a gripping feature 158. In some instances, the container cleaner 500 may be positioned within a sink (e.g., sink 110 in FIG. 1) such that a corner of the sink abuts a container wall exterior or a container handle and prevents rotation of the container. In embodiments where the anti-rotation device 150 utilizes an arm, the arm may extend from the container cleaner body 102 or may be mounted in a sink (e.g., sink 110 in FIG. 1), on a counter, or the like. In the embodiment illustrated in FIG. 8, the anti-rotation device 150 includes an arm 152 that extends from the container cleaner body 102 proximate the first end 101. The arm 152 may include one or more adjustable portions 154, 156 that adjust in one or more directions to allow for differently sized containers. For example, the adjustable portions 154, 156 may be coupled to actuators (not shown) that adjust various dimensions of the container cleaner 500 (and components thereof) to match a size, dimension, or the like of a particular container to be cleaned by the container cleaner 500. In some aspects, the adjustable portions 154, 156 can be programmably adjustable (e.g., for a particular time period, wash cycle, or the like) to automatically adjust according to a program. The arm 152 may also include the gripping feature 158 adapted to grip at least a portion of a container to help prevent rotation thereof with respect to the container cleaner body 102.

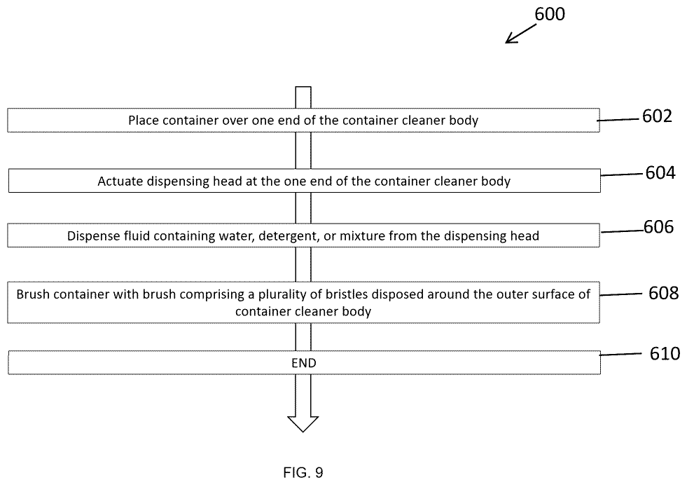

Referring now to FIG. 9 and with reference to the different embodiments of the container cleaners 100, 200, 300, 400, 500 illustrated in FIGS. 1-8, it is to be appreciated that defined herein is a method 600 for cleaning a container. At step 602 of the method 600, a container (e.g., container 105 shown in FIG. 5B) is placed over one end (e.g., the second end 103) of the container cleaner body 102. At step 604, the dispensing head 104 disposed at the one end of the container cleaner body 102 is actuated (e.g., by depressing the dispensing head 104). This causes the dispensing head 104 to dispense a fluid at step 606, wherein the fluid includes water, detergent, or a mixture of water and detergent. At step 608, the container (e.g., container 105 shown in FIG. 5B) is brushed with a brush 106 including a plurality of bristles 108 disposed around at least a portion of an outer surface of the container cleaner body 102. At step 610, the method 600 ends. Brushing with the brush 106 may further include rotating the brush 106 with the motor 114 or with water pressure from the water line 122 in communication with a fluid pathway 134 extending within the container cleaner body 102. In some embodiments, at least a portion of the container (e.g., container 105 shown in FIG. 5B) is placed against a gripping feature 158 formed on an arm 152 extending adjacent to the container cleaner body 102 to prevent rotation of the container with respect to the container cleaner body 102. In additional embodiments, the container (e.g., container 105 shown in FIG. 5B) is further sanitized with one or more UV emitting lights 140 disposed on at least one of the container cleaner body 102, the dispensing head 104, and the brush 106.

As noted herein, the container cleaners described herein can be programmed to adjust various cleaning settings, parameters, wash times, rinse times, sanitizing schedules, and/or the like in accordance with various scenarios, such as a detected type of container, a number of times a container has been through a particular cycle, an amount of time that has elapsed, and/or the like. As such, it should be appreciated that the various configurations described throughout herein can be programmably controlled in accordance with particular scenarios.

It should be appreciated that although various embodiments of container cleaners are illustrated herein each included individual components, each of the various embodiments of container cleaners are equipped to incorporating any one or more of the individual components. Accordingly, a container cleaner may include any number or combination of components although not specifically illustrated in any single figure.

From the above, it is to be appreciated that defined herein is a container cleaner apparatus and method that provide automated rinsing, sanitizing, and brushing of containers by an integrated unit that is mountable to or otherwise fits within a sink.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A container cleaner, comprising:
a container cleaner body extending between a first end and a second end, the first end including a fluid inlet and the second end including a fluid outlet;
a fluid pathway formed within the container cleaner body in communication with the fluid inlet and the fluid outlet;
a dispensing head disposed at the second end of the container cleaner body including one or more nozzles in communication with the fluid outlet;
a brush comprising a plurality of bristles disposed around at least a portion of an outer surface of the container cleaner body; and
a detergent reservoir in communication with the fluid pathway of the container cleaner body.

2. The container cleaner of claim 1, wherein the plurality of bristles are disposed adjacent to the dispensing head and extend outward from the dispensing head at various angles.

3. The container cleaner of claim 1, wherein the plurality of bristles comprise rubber bristles.

4. The container cleaner of claim 1, wherein the brush is rotatable about a longitudinal axis of the container cleaner body extending between the first end and the second end of the container cleaner body.

5. The container cleaner of claim 4, further comprising a motor for driving rotation of the brush.

6. The container cleaner of claim 1, wherein the brush is movable upward and downward in a vertical direction with respect to the container cleaner body.

7. The container cleaner of claim 1, wherein the brush is integrally formed as a one-piece, monolithic structure with the container cleaner body.

8. The container cleaner of claim 1, wherein the brush is formed separate and removable from the container cleaner body.

9. The container cleaner of claim 1, further comprising a detergent valve fluidly coupled to the detergent reservoir and in communication with the fluid pathway, wherein the detergent valve is configurable between an open position to dispense detergent into the fluid pathway and a closed position to retain the detergent in the detergent reservoir.

10. The container cleaner of claim 9, further comprising a mixing chamber in communication with the detergent valve, the fluid pathway, and a water line.

11. The container cleaner of claim 1, further comprising a pump in communication with the detergent reservoir.

12. The container cleaner of claim 1, further comprising an arm that extends adjacent to the container cleaner body and includes a gripping feature to grip at least a portion of a container and prevent rotation of the container with respect to the container cleaner body.

13. The container cleaner of claim 1, further comprising one or more ultraviolet emitting lights disposed on at least one of the container cleaner body, the dispensing head, and the brush.

14. A method for cleaning a container, the method comprising:
placing the container over one end of a container cleaner body;
actuating a dispensing head disposed at the one end of the container cleaner body;
dispensing a fluid from the dispensing head, wherein the fluid comprises water, detergent, or a mixture of water and detergent; and
brushing the container with a brush comprising a plurality of bristles disposed around at least a portion of an outer surface of the container cleaner body.

15. The method of claim 14, wherein brushing the container further comprises rotating the brush with a motor or with water pressure from a water line in communication with a fluid pathway extending within the container cleaner body.

16. The method of claim 15, further comprising placing at least a portion of the container against a gripping feature formed on an arm extending adjacent to the container cleaner body to prevent rotation of the container with respect to the container cleaner body.

17. The method of claim 14, further comprising sanitizing the container with one or more ultraviolet emitting lights disposed on at least one of the container cleaner body, the dispensing head, and the brush.

18. A container cleaner, comprising:
a container cleaner body including a fluid inlet disposed at a first end of the container cleaner body, a fluid outlet disposed at a second end of the container cleaner body, and a fluid pathway extending within the container cleaner body between the fluid outlet and the fluid inlet;
a dispensing head disposed at the second end of the container cleaner body including one or more nozzles in communication with the fluid outlet;
a brush disposed on the container cleaner body including a brush body, a plurality of bristles attached to at least a portion of an outer surface of the brush body, and one or more apertures formed on the brush body, the one or more apertures being in communication with the one or more nozzles of the dispensing head; and
a detergent reservoir in communication with the fluid pathway of the container cleaner body.

19. The container cleaner of claim 18, further comprising one or more ultraviolet emitting lights disposed on at least one of the container cleaner body, the dispensing head, and the brush body.

20. The container cleaner of claim 18, wherein the brush is rotatable about a longitudinal axis of the container cleaner body extending between the first end and the second end of the container cleaner body.
